(19) United States
(12) Patent Application Publication
(10) Pub. No.: US 2020/0179083 A1
(43) Pub. Date: Jun. 11, 2020

(54) DENTAL RESTORATION STRIP AND METHOD OF USE

(71) Applicant: Robyn Britt Lesser, Clearwater, FL (US)

(72) Inventor: Robyn Britt Lesser, Clearwater, FL (US)

(21) Appl. No.: 16/214,871

(22) Filed: Dec. 10, 2018

(51) Int. Cl. A61C 5/85; A61C 5/68

(52) U.S. Cl. CPC A61C 5/85; A61C 5/88; A61C 5/68

(57) ABSTRACT

Disclosed are various embodiments of a dental strip with elastic characteristics. The dental strip can be used for dental restoration procedure, particularly for maintaining a dry and clean area for one or more teeth. The dental strip can include a strip of elastic material. The strip has an elongated body between a first end and a second end. The elongated body comprises an upper surface and a lower surface that extend parallel between a first edge and a second edge. At least one of the upper and lower surfaces having a first edge strip and a second edge strip situated respectively along the first edge and the second edge. At least one of the first edge strip and the second edge strip being used to stabilize the strip at a position between at least two teeth of a human.

### BACKGROUND

Dental restoration on certain teeth can be technique sensitive. Dentists have to maintain a dry and clean field while also shaping and restoring a tooth's anatomy. Depending on the tooth, dentists oftentimes use a matrix and a wedge during a dental restoration procedure. However, these dental tools and others can be problematic in certain scenarios.

### SUMMARY

Embodiments of the present disclosure are related to an improved dental strip for dental restoration procedures.

In one embodiment, among others, an apparatus comprises a strip of elastic material. The strip includes an elongated body between a first end and a second end. The elongated body comprising an upper surface and a lower surface that extend parallel between a first edge and a second edge. The elongated body having a width from the first edge to the second edge in a range between 5 millimeters to 50 millimeters. At least one of the upper surface and lower surface has a first edge strip and a second edge strip situated respectively along the first edge and the second edge. Each of the edge strips may have a thickness in a range of about 0.1 millimeter to about 1 millimeter. The first edge strip and the second edge strip can be used to stabilize the strip at a position between at least two teeth of a human.

In another embodiment, among others, a method of installing a dental restoration strip comprising a step of aligning a raised edge strip of an elastic strip between two teeth of a patient. The raised edge strip can be situated at an edge of the elastic strip. The raised edge strip can have a first thickness that is greater than a second thickness of an elongated body of the elastic strip. Next, the method includes a step of inserting the raised edge strip of the elastic strip between the two teeth. Then, the method includes a step of positioning the raised edge strip of the elastic strip along a gum line of the teeth. The raised edge strip can stabilize the elastic strip at a location along the gum line. Then, the method includes the step of manipulating the elastic strip to cover a restoration area of one of the two teeth.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a perspective view of a dental strip, according to one embodiment described herein.

FIG. 2A illustrates a side view of the dental strip from FIG. 1, according to one embodiment described herein.

FIG. 2B illustrates a top view of the dental strip from FIG. 1, according to one embodiment described herein.

FIG. 2C illustrates a drawing of a front view of the dental strip from FIG. 1 inserted between anterior teeth, according to one embodiment described herein.

FIG. 2D illustrates a drawing of a front view of the dental strip inserted between the anterior teeth shown in FIG. 2C with a portion of the dental strip removed from view, according to one embodiment described herein.

FIG. 3 illustrates a side view of another dental strip, according to one embodiment described herein.

FIG. 4 is a flow chart illustrating an example of method of use of the dental strip from FIG. 1 according to various embodiments of the present disclosure.

### DETAILED DESCRIPTION

Dental restoration involves a process for restoring the function, integrity, and esthetic of teeth. During restoration procedures, dentists use an array of tools to maintain a dry and clean field while shaping and restoring a tooth's anatomy. Depending on the teeth being operated on, certain tools and restoration techniques may be required during a restoration procedure.

Resin or glass ionomer restorations can be more affective when they are not contaminated by saliva and or blood. This can be difficult when restoring the interproximal surface (mesial or distal) of a tooth. Oftentimes, a matrix is used if the teeth are in contact with the proximal tooth. The matrix can enable the dentist to shape or mold the material with instruments, and the matrix prevents the materials from bonding to the adjacent tooth. The bonding materials used may include composite resins (whether packable or flowable), compomers, and glass ionomers. Generally, a Mylar matrix is used for dental restoration procedures. However, the use of the Mylar matrix can be technique sensitive because it requires the coordination of multiple tools during a procedure. Further, even though it is flexible, it does have a sharp edge that can cause bleeding to occur when placed into the sulcus of the gingiva. Additionally, the Mylar matrix oftentimes is used in combination with a wedge or stabilizer to help maintain the position of the Mylar matrix. These tools can be placed sub gingival. Wedges may also be traumatic to the tissue because they can cause the area to bleed and may impact the bond of the dentist's restorative material to the tooth. If a wedge or stabilizer is not used, the matrix may move during a restoration procedure. As a result, the dentist must hold the matrix with their non-dominant hand while completing the restoration. This coordination of tools can be difficult when the backside or palatal side of the tooth is also being restored. A dentist would not be able to hold the dental mirror and the matrix while placing the materials all at the same time. These tools can also be painful or very uncomfortable for the patient. Patients are oftentimes given a numbing agent to help tolerate pain during the procedure.

The various embodiments of the present application relate to an improved dental restoration strip that helps seal off at least a portion of a tooth area from moisture during a dental restoration procedure. The embodiments prevent bonding materials (e.g. resin and other materials) from attaching to an adjacent tooth and help the dentist achieve a smooth finish for the tooth being operated on. The various embodiments of the dental restoration strip have the benefit of being able to self-stabilize after being inserted into a position between teeth. Accordingly, another dental instrument, such as wedge, is not needed in order for the embodiments to maintain their position. This relieves the dentist of having to hold and coordinate the use of another dental instrument. Additionally, the embodiments are comprised of material soft enough that the gingiva are not traumatized, which improves patient comfort during a restoration procedure. Particularly, a numbing agent is not required because of the minimal impact the embodiments have on the gum tissue. Further, the structure and materials of the embodiments enable for flexibility and stretchability. These aspects allow for a dentist to manipulate the strip in a variety of positions while still being ridged enough to maintain a desired position.

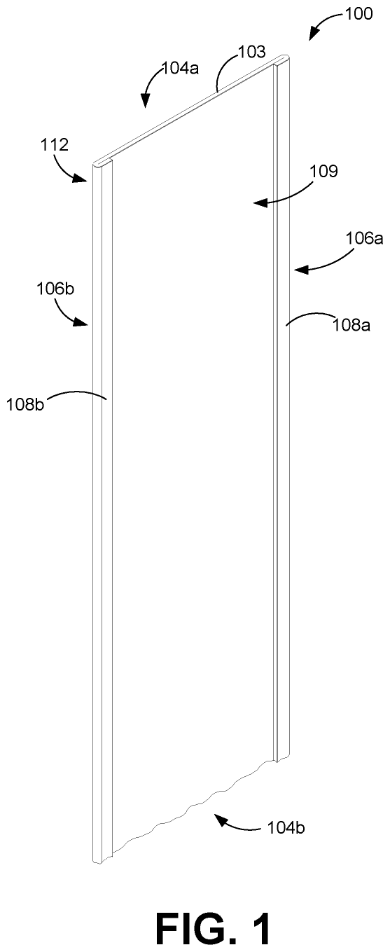

With reference to FIG. 1, shown is a drawing of a perspective view of a dental strip 100. The dental strip 100 comprises a body 103, a first end 104a, a second end 104b, a first edge 106a, and a second edge 106b. The dental strip 100 can be comprised of a material with flexible and/or elastic properties. For example, the dental strip 100 may be comprised of material such as polytetrafluroethylene (PTFE), latex, synthetic latex, nitrile rubber, polyvinvyl chloride, neoprene, and other suitable materials with flexible and/or elastic properties. These materials have properties that are useful for dental restoration procedures. For example, many of these materials can be used for sealing off an area one or more teeth from moisture. During a restoration procedure, the dentist needs to maintain a dry and clean area, particularly sealed off from blood, water, saliva, and other liquids. In addition, these materials can be useful because bonding agents used during the restoration procedure are not prone to adhere to these materials. As a result, dental strips 100 comprises of these materials can be useful for shaping the anatomy of a tooth during a restoration procedure. For example, in one embodiment, the dental strip 100 can be comprised of Telfon® material.

As shown in FIG. 1, the first edge 106a and the second edge 106b (collectively “edges 106”) extend longitudinally along the body 103. Further, the dental strip 100 comprises a first edge strip 108a and a second edge strip 108b (collectively “edge strips 108”) at the respective first edge 106a and the second edge 106b. Although FIG. 1 depicts the dental strip 100 with two edge strips 108, the dental strip 100 may include one or more than two edge strips 108. In some embodiments, two edge strips 108 can increase the rigidity of the dental strip 100, which can strengthen the ability of the dental strip 100 to maintain a particular orientation and/or location.

The body 103 can have an elongated shape between the first end 104a and the second end 104b. The body 103, along with other aspects of the dental strip 100, can be flexed, distorted, stretched, and manipulated for a variety of different positions. The body 103 comprises an upper surface 109 and a lower surface 112. The upper surface 109 and the lower surface 112 are generally flat. As depicted in FIG. 1, the upper surface 109 of the dental strip 100 comprises the edge strips 108, and the edge strips 108 are omitted from the lower surface 112. In some embodiments, the upper surface 109 may be positioned to seal off a restoration area. Particularly, the upper surface 109 may be used to substantially wrap around one or more teeth that are being restored. In this scenario, the upper surface 109 may come into contact with the tooth because the upper surface 109 is oriented toward the area of the one or more teeth being restored. The lower surface 112 can be the opposing side of the dental strip 100. In some scenarios, the lower surface 112 can be oriented away from the dental restoration area.

The edge strips 108 can be used to maintain an orientation and/or a position of the dental strip 100 along a gum line. As depicted in FIG. 1, the edge strips 108 have rolled edges, where the ends 106 of the dental strip 100 are rolled toward an interior portion of the body 103. This arrangement causes the edge strips 108 to have a curve at the end of the edges along a length of the dental strip 100. The edge strips 108 have a thickness that is greater than the body 103. In other embodiments, the dental strip 100 comprises edge strips 108 where the rolled aspect is omitted. In these embodiments, the edge strips 108 may have a raised edge with a thickness that is larger than a thickness of the body 103. As one skilled in the art can appreciate, the edge strips 108 have other shapes. The edge strips 108 can have an elastic property that enables them to contract during an insertion of the dental strip 100 through a tight area between teeth. Then, the edge strips 108 can expand after passing through the tight area in order to maintain a particular position and/or orientation. For example, by applying pressure to the edge strips 108, the edge strips 108 can contract. Then, the contracted edge strip 108 of the dental strip 100 can be inserted between the two teeth similar to inserting a flossing thread. The contracted edge strip 108 is inserted toward a gum line of the patient. After the contracted edge strip 108 has passed through a tight area, the edge strip 108 can expand to stabilize its position and/or orientation. In some embodiments, the edge strips 108 can remain in a contracted state.

In some embodiments, the edge strips 108 may remain in a contracted or collapsed state for a period of time after initially being compressed. In some cases, the edge strip 108 may be comprised of a material that remains collapsed for a period of time after being compressed and gradually expands to a normal state after the compressed force has been relieved. In these cases, the edge strip 108 may be comprised of a first material that is different from a second material used for the body 103. For example, the first material of the edge strip 108 may be comprised of foam or some other suitable material that can remain collapsed for a period of time after the force being applied has been released from the material. In some scenarios, the first edge strip 108a may be positioned along the gum line of a patient, and the second edge strip 108b may be positioned on a far end of the tooth, away from the gum line.

In some embodiments, the upper surface 109 may be comprised of a first material, and the lower surface 112 may be comprised of a second material. Since the upper surface 109 may come into contact with the restoration area, the first material may have unique properties for protecting the tooth restoration area. The second material for the lower surface 112 may have a different set of properties considering that it is oriented away from the restoration area.

The embodiments of the dental strip 100 can be packaged in a variety of forms. For example, in some embodiments, the dental strip 100 may be manufactured as one elongated strip that is wrapped around a spool. Dentists can cut off a first length for a first procedure and cut off a second length for a second procedure. In other embodiments, a predefined length of the dental strip 100 can be packaged within two disposable sheets, similar to bandage packaging. For example, the dental strip 100 may be manufactured to have a length in a range of 40 to 160 millimeters and a width in a range of 5 millimeters to 50 millimeters.

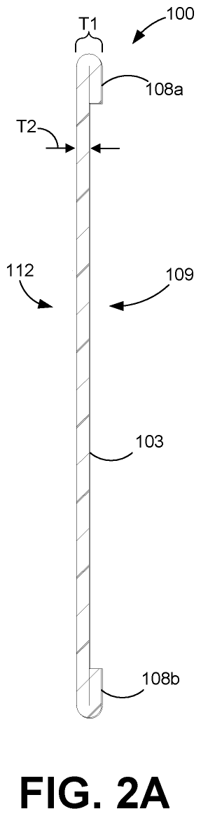

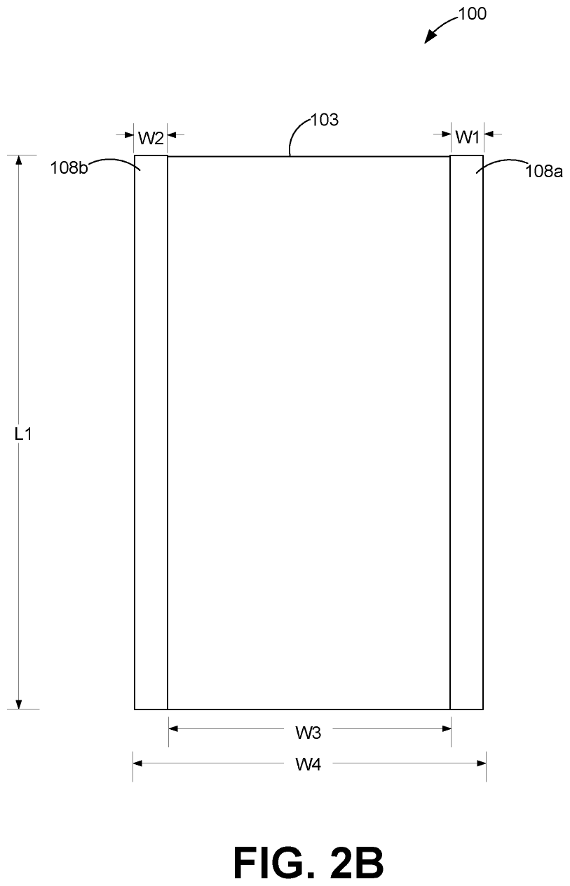

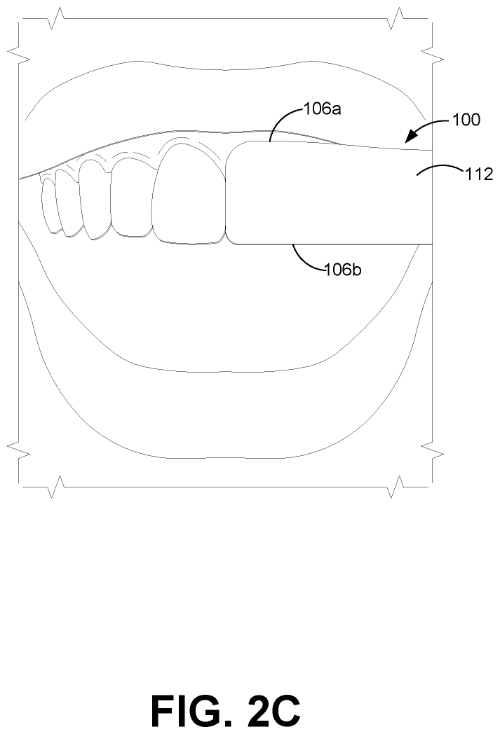

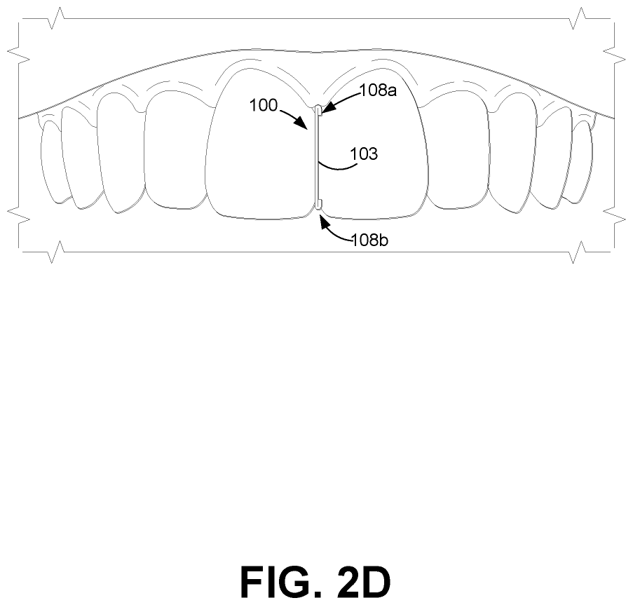

With reference to FIG. 2A, shown is side view of the dental strip 100 from FIG. 1. As shown in FIG. 2A, the edge strip 108 can have a thickness “T1” that is larger than a thickness “T2” for the body 103. Particularly, with respect to FIG. 2A, the thickness “T1” is depicted as being doubled the distance of thickness “T2.” In another embodiment, thickness “T1” can be 50% greater in distance than thickness “T2.” As one skilled in the art appreciates, the difference in distance between the thickness “T1” and thickness “T2” can vary. In some embodiments, the thickness “T1” can vary in a range of 0.1 millimeter to about 1 millimeter. Additionally, in some embodiments, the thickness “T2” can vary in a range of 0.05 millimeter to 0.5 millimeter. Further, although the edge strips 108 are shown as having curved ends, those skilled in the art can appreciate that the shape of the edge strips 108 can vary. FIG. 2B depicts a top view of the dental strip 100 from FIG. 1. As shown in FIG. 2B, the edge strips 108 have widths “W1,” “W2” that are less than a width “W3” for the body 103. In some embodiments, the widths “W1,” “W2” can vary in comparison to width “W3.” For example, in one embodiments, the widths “W1,” “W2” may be one-half to one millimeter. As one skilled in the art can appreciate, the widths “W1,” “W2” can vary. In other embodiments, a first width “W1” for the first edge strip 108a can vary from a second width “W2” for the second edge. Further, the dental strip 100 comprises a length “L1” and a width “W4.” In some embodiments, the width “W4” can comprise a range between 5 millimeters to 50 millimeters. In FIG. 2B, the edge strips 108 extend along the length “L1” of the dental strip 100. In other embodiments, the edge strips 108 may extend for a portion of the length “L1” of the dental strip 100.

Moving on to FIG. 2C, shown is a drawing of a back view of the dental strip 100 from FIG. 1 positioned in a mouth of a patient, as one non-limiting example. Particularly, the lower surface 112 of the dental strip 100 is in view in FIG. 2C. In FIG. 2C, the dental strip 100 is positioned between two anterior teeth. The first edge 106a is positioned near the gum line of the patient and the second edge 106b is positioned at the other end of the tooth away from the gum line. In FIG. 2C, the edge strips 108 (FIG. 1) are oriented inward toward the mouth of the patient and as a result they are omitted from view in FIG. 2C. In FIG. 2D, shown is the dental strip 100 inserted between the anterior teeth shown in FIG. 2C with a portion of the dental strip 100 removed from view. Particularly, FIG. 2D illustrates that the edge strips 108 are in an expanded state to stabilize the position of the dental strip 100 between the two anterior teeth. Specifically, the first edge strip 108a is in an expanded state near the gum line, and the second edge strip 108b is in an expanded state near the other end of the teeth. In other words, in this example, the edge strips 108 help secure or stabilize the dental strip 100 at the desired location. Thus, in FIG. 2D, the dental strip 100 is secured by the two locations of the two edge strips 108. As one skilled in the art can appreciate, the dental strip 100 may be secured by one or more than two locations of edge strips 108.

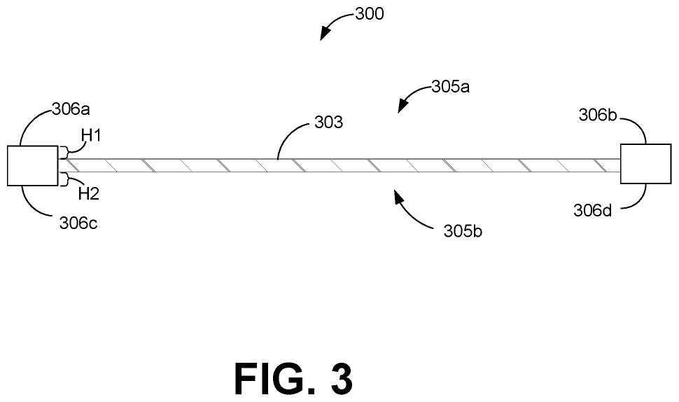

Moving on the FIG. 3, shown is side view of an alternative dental strip 300. In the FIG. 3, the dental strip 300 comprises a body 303, a first side 305a, and a second side 305b. The first side 305a includes a first raised edge 306a at one end and a second raised edge 306b at the other end of the dental strip 300. The second side 305b includes a third raised edge 306c and a fourth raised edge 306d. The first raised edge 306a, the second raised edge 306b, the third raised edge 306c, and the fourth raised edge 306d (collectively the raised edges 306) extend from the body 303. The raised edges 306a,306c have a height “H1” on the first side 305a of the body 303. The raised edges 306b,306d have a height “H2” on the second side 305b of the body 303. In some embodiments, height “H1” and height “H2” may be the same, substantially the same, or of different distances. In these embodiments, the raised edges 306 can extend along the length of the dental strip 300, similar to the dental strip 100 of FIG. 2B.

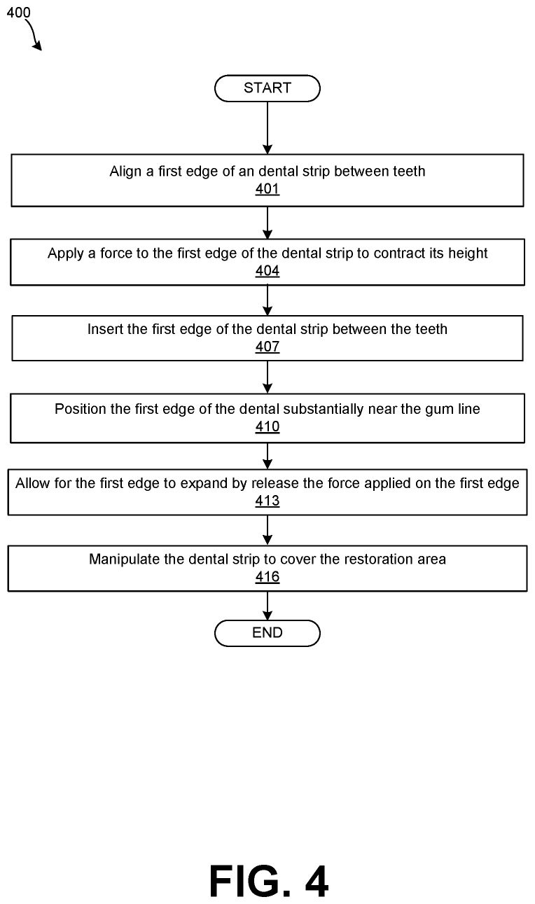

With reference to FIG. 4, shown is a flowchart that provides one example of a method of use for the dental strip 100 from FIG. 1 according to various embodiments. Particularly, FIG. 4 illustrates a flow chart for an example process 400 for installing the dental strip 100.

Beginning with box 401, the process 400 involves aligning a first edge strip 108a of the dental strip 100 between two teeth. In some scenarios, the upper surface 109 of the dental strip 100 can be oriented toward the restoration area of one or more teeth. In other scenarios, either the upper surface 109 or the lower surface 112 can be oriented toward the restoration area.

In box 404, the process 400 involves applying a force to the first edge strip 108a of the dental strip 100 in order to contract a height of the first edge strip 108a. By reducing the height of the first edge strip 108, it is easier to insert through tight areas between the teeth. In some examples, the dentist may apply pressure to the first edge strip 108a by squeezing the first edge strip 108. In some embodiments, the edge strips 108 may be comprised of a material that upon being pressured maintains a contracted state for a period of time before gradually expanding to a normal state. In some scenarios, this step of the process 400 is omitted.

In box 407, the process 400 involves inserting the first edge strip 108a of the dental strip 100 between the teeth. The insertion involves moving the first edge strip 108 in a direction toward the gum line of the patient. In some embodiments, where box 404 is omitted, the first edge strip 108b may be compressed as the first edge strip 108a is moved toward the gum line.

In box 410, the process 400 involves positioning the first edge strip 108 at or substantially near the gum line of the patient. With the first edge strip 108a at the gum line, the dental strip 100 can be manipulated to provide sufficient coverage of the restoration area of the one or more teeth.

In box 413, the process 400 involves releasing the force applied to the first edge strip 108a. Upon the force being relieved, the first edge strip 108a of the dental strip 100 can expand back to a normal state. In its normal state, the thickness or height of the first edge strip 108a can stabilize the dental strip 100 at a particular position and orientation. With the dental strip 100 stable or secured at a desire position, the dentist is free to use his or her hands for other tools. In some scenarios, this step is omitted from process 400.

In box 416, the process 400 involves manipulating the dental strip 100 to cover the restoration area of one or more teeth. In some cases, this step involves substantially wrapping the dental strip 100 around one or more teeth. With the first edge strip 108a along the gum line, the dental strip 100 can seal off the restoration area from liquids and other materials that could affect the bonding process or contaminate the area.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. An apparatus for use when performing a dental restoration process, the apparatus comprising:
a strip of elastic material, the strip having an elongated body between a first end and a second end, the elongated body having an upper surface and a lower surface that extend parallel between a first longitudinal edge and a second longitudinal edge, the elongated body having a width from the first longitudinal edge to the second longitudinal edge in a range between 5 millimeters to 50 millimeters; and
at least one of the upper surface and lower surface having a first elongated edge strip and a second elongated edge strip situated respectively along the first longitudinal edge and the second longitudinal edge, each of the elongated edge strips having a thickness in a range of about 0.1 millimeter to about 1 millimeter, the first elongated edge strip and the second elongated edge strip being used to stabilize the strip at a position between at least two teeth of a human.

2. The apparatus of claim 1, wherein the first elongated edge strip and the second elongated edge strip are attached to an underlying part of the one of the upper surface and the lower surface of the strip.

3. The apparatus of claim 1, wherein at least one of the first elongated edge strip and the second elongated edge strip are positioned on the upper surface of the strip.

4. The apparatus of claim 1, wherein at least one of the first elongated edge strip and the second elongated edge strip are positioned on both the upper surface and the lower surface of the strip.

5. The apparatus of claim 1, wherein the strip comprises polytetrafluroethylene.

6. The apparatus of claim 1, wherein at least one of the first elongated edge strip and the second elongated edge strip has a first thickness that is at least 50 percent greater than a second thickness of the elongated body.

7. The apparatus of claim 1, wherein at least one of the first elongated edge strip and the second elongated edge strip is configured to be positioned along a gum line of the human.

8. The apparatus of claim 1, wherein at least one of the first elongated edge strip and the second elongated edge strip is formed by bending at least one of the first longitudinal edge or the second longitudinal edge upon itself at least once so that the thickness of the at least one of the first longitudinal edge strip and the second longitudinal edge strip is a multiple of the thickness of the elongated body.

9. The apparatus of claim 1, wherein the thickness comprises a first thickness, and the elongated body of the strip comprises a second thickness which varies in a range from 0.05 millimeter to 0.5 millimeter.

10. The apparatus of claim 1, wherein the strip comprises at least one of latex, nitrile rubber, polyvinvyl chloride, and neoprene.

11. The apparatus of claim 1, wherein at least one of the first elongated edge strip and the second elongated edge strip can be compressed to a contracted state.

12. The apparatus of claim 1, wherein the strip is substantially wrapped around a part of one of the at least two teeth and wherein the first elongated edge strip passes adjacent to gums of the human and between the at least two teeth of the human.

13. A method of installing a dental restoration strip, comprising:
aligning a raised edge strip of an elastic strip between two teeth of a patient, wherein the raised edge strip is situated at an edge of the elastic strip, wherein the raised edge strip has a first thickness that is greater than a second thickness of an elongated body of the elastic strip, wherein the first thickness is in a range of about 0.1 millimeter to about 1 millimeter;
inserting the raised edge strip of the elastic strip between the two teeth;
positioning the raised edge strip of the elastic strip along a gum line of the teeth, wherein the raised edge strip stabilizes the elastic strip at a location along the gum line; and
manipulating the elastic strip to cover a restoration area of one of the two teeth.

14. The method of claim 13, further comprising:
applying a force to the raised edge strip of the elastic strip to contract the first thickness of the raised edge strip.

15. The method of claim 14, further comprising:
releasing the force applied to the raised edge strip in order to allow the height of the raised edge strip to expand from a contracted state to a normal state.

16. The method of claim 13, wherein aligning the raised edge strip of the elastic strip between two teeth of the patient further comprises orientating an upper surface of the elastic strip toward a restoration area, wherein the upper surface of the elastic strip comprises the raised edge strip.

17. The method of claim 13, wherein the raised edge strip comprises a first raised edge strip on an upper surface of the elastic strip and a second raised edge strip on a lower surface of the elastic strip.
